(19) United States
(12) Patent Application Publication
(10) Pub. No.: US 2024/0139992 A1
(43) Pub. Date: May 2, 2024

(54) COMPRESSED CELLULOSIC FIBER PRODUCTS AND METHOD FOR PRODUCING THEM

(71) Applicant: NaturLoop AG, Biel (CH)

(72) Inventors: Michail Kyriazopoulos, Biel (CH); Sauro Bianchi, Zürich (CH); Frédéric Pichelin, Säriswil (CH)

(21) Appl. No.: 18/548,464

(22) PCT Filed: Feb. 28, 2022
(86) PCT No.: PCT/EP2022/054959

§ 371 Date: Aug. 30, 2023

(30) Foreign Application Priority Data
Mar. 1, 2021 (CH) 00220/21

(51) Int. Cl. B27N 3/04; B27N 1/00; B27N 3/00; C08L 97/02

(52) U.S. Cl. CPC B27N 3/04; B27N 1/003; B27N 1/006; B27N 3/002; C08L 97/02; B27N 1/0227

(57) ABSTRACT

A method for producing a compressed cellulosic fiber product and a compressed cellulosic fiber product manufactured from cellulosic raw material using this method. The method comprises the steps of: (i) providing cellulosic raw material comprising cellulosic fibers; (ii) treating the cellulosic raw material with an adhesive composition to obtain a raw mass; and (iii) compressing the raw mass in a pre-defined form to effect condensation to obtain the compressed cellulosic fiber product.

### FIELD OF DISCLOSURE

The invention relates to a method for producing compressed cellulosic fiber products. More particularly, the invention relates to compressed cellulosic fiber products for indoor and outdoor use and methods for making such products.

### BACKGROUND, PRIOR ART

Compressed cellulosic fiber products, such as fiberboards, particleboards or artificial wood boards, are engineered panel products manufactured from various raw materials, such as wood chips, sawmill shavings, sawdust and fibers. The raw materials are typically fibrous and may additionally include filling materials. The raw materials are then pressed and bonded together using an adhesive.

The resulting fiberboards manufactured by such processes are generally differentiated on the basis of their density: They include Low Density Fiberboards (also known as LDF), Medium Density Fiberboards (also known as MDF), and hardboards (High Density Fiberboards, also known as HDF). The fiberboards, particularly MDFs, are often used in the furniture and building industry.

The raw materials used for manufacturing compressed cellulosic fiber products, such as fiberboards, are typically milled into particles and/or fibers first. The particles and/or fibers are then typically bound together using an adhesive, such as a chemical binder. The resulting mixture is then typically formed into a mat and then pressed into the final product. During this pressing, the adhesive is hardened, which may involve formation of covalent bonds. Finally, the compressed cellulosic fiber products are cooled and typically trimmed to size and sanded.

Several processes for manufacturing compressed cellulosic fiber products use raw materials which are cut for the sole purpose of manufacturing the compressed cellulosic fiber products. The cutting is often associated with deforestation, which is associated with pollution. Furthermore, the raw materials used in several processes are expensive and only grow in certain regions of the world.

### SUMMARY OF DISCLOSURE

Although many methods for manufacturing compressed cellulosic fiber product from cellulosic raw material have been developed until today, they suffer from a range of disadvantages, including high cost. In particular, the cellulosic raw material used for manufacturing the compressed cellulosic fiber products is often expensive.

An additional disadvantage is that the cellulosic raw material used for making the compressed cellulosic fiber products is often not renewable and/or not environmentally friendly. As an example, for several of the cellulosic raw materials known for manufacturing compressed cellulosic fiber products, deforestation is required to obtain the cellulosic raw material in sufficient quantities, particularly under conventional harvesting policies. In particular, for several of the cellulosic raw materials used in known manufacturing processes, deforestation would not be done if it were not for the manufacturing of compressed cellulosic fiber products. Additionally, the deforestation required to obtain the cellulosic raw material often imposes a significant toll on the environment. As an example, the deforestation frequently has a high carbon dioxide footprint.

An additional disadvantage is that depending on the raw materials used, such as the cellulosic raw material or the adhesive, regional availability is limited and frequently does not match the manufacturing location and/or the region where the manufactured compressed cellulosic fiber products will be used. As an example, several of the cellulosic raw materials used in the known manufacturing processes are not available in all countries of the world, such as south-east Asian countries like the Philippines, Indonesia, Malaysia, Singapore, Thailand, Cambodia, Laos, etc. This means that the manufactured compressed cellulosic fiber products need to be imported to these countries, which is costly and environmentally unfriendly.

Finally, the adhesive is usually a thermosetting or heat-curing polymer and typically includes toxic components such as formaldehyde or derivatives or surrogates thereof. Urea-Formaldehyde (UF) or Melamine Urea Formaldehyde (MUF) are among the most frequently used in the manufacturing of compressed cellulosic fiber products, particularly fiberboards and particleboards. Some drawbacks of those adhesives are that they are not safe and environmentally friendly (i.e. not “green”) because they are manufactured from petrochemical sources and emit hazardous emissions such as formaldehyde which is classified as “probable human carcinogen” and other toxic Volatile Organic Compounds (VOC).

It is therefore the general objective of the present invention to advance the state of the art with respect to manufacturing compressed cellulosic fiber products. In advantageous embodiments, the disadvantages of the prior art are overcome fully or partly. Preferably, an environmentally friendly, sustainable and/or cost-effective method to manufacture compressed cellulosic fiber products is provided. The new method ideally results in compressed cellulosic fiber products, such as fiberboards, which have a medium density. Preferably, the new method would at least partially use raw materials that are waste products from other commercial processes and/or that pose a burden on the environment. In advantageous embodiments, the cellulosic raw material used would derive from agricultural side-streams or agricultural by-products. The new method ideally results in compressed cellulosic fiber products, such as fiberboards, which have advantageous physical properties, mechanical properties and/or aesthetic properties. Further, the new method would ideally use a raw material that is at least one of the following: cheap, readily available, especially in South-East Asian countries, environmentally friendly, sustainable and recyclable. In advantageous embodiments, the new method grants cheap and non-pollutive access to compressed cellulosic fiber products, such as fiberboards, which may be used, among other things, in the furniture and construction industry. This would contribute to supplying affordable, sustainable and/or environmentally friendly cellulosic fiber products that may, for example, be used as furniture.

The general objective is achieved in a first aspect of the invention by a method for manufacturing compressed cellulosic fiber products, the method comprising the steps of:
i) providing cellulosic raw material comprising cellulosic fibers;
ii) treating the cellulosic raw material with an adhesive composition to obtain a raw mass;
iii) compressing the raw mass in a pre-defined form to effect condensation to obtain the compressed cellulosic fiber product.

Compressed cellulosic fiber product as used herein refers to a pressure formed cellulosic fiber product, i.e. a cellulosic fiber product formed by application of pressure to the cellulosic fiber during its production. In preferred embodiments, the cellulosic fiber product is formed by application of pressure and/or temperature to the cellulosic fibers during its production, wherein application of temperature in particular refers to heating, such as heating above 100° C., in particular above 150° C. If pressure and temperature are both applied during production of the cellulosic fiber product, they are preferentially applied simultaneously for at least some period of time. In this embodiment, it is additionally possible that during further periods of time, a pressure is applied at room temperature and/or a temperature higher than room temperature is applied without applying a pressure.

In some embodiments, the compression is performed in a mold. A mold, as used herein, is a three-dimensional structure delimiting a volume which is used for application of a pressure during the production of the compressed cellulosic fiber product. In these embodiments, the compressed cellulosic fiber product is a molded cellulosic fiber product. The mold may be essentially identical or essentially complementary to a final target shape of the molded cellulosic fiber product.

Molded cellulosic fiber products include products made from cellulosic raw material that was molded during the production process. Molding includes bringing a raw material or an intermediate product derived from the raw material into a particular shape or form using a frame, mold or matrix. In a typical embodiment, the frame, mold or matrix is essentially complementary in shape and/or form to the desired shape or form of the cellulosic fiber product. The raw material or intermediate product brought into a particular shape or form by molding is pliable.

Cellulose refers to a polysaccharide constituting an important structural component of the primary cell wall of green plants and many forms of algae. It comprises a linear chain of hundreds to many thousands of β(1→4) linked D-glucose units.

Cellulosic fiber products refer to products made from cellulosic fibers. This does not mean that the cellulosic fiber products are made exclusively from cellulosic fibers. Rather, other raw materials might be comprised in the manufacturing process towards cellulosic fiber products in addition to cellulosic fibers. Cellulosic fibers preferably include ethers and/or esters of cellulose. Cellulosic fibers may be obtained from various different raw materials, including the wood, leaves or bark of plants. Cellulosic fibers are preferably natural fibers.

The adhesive composition includes at least one adhesive or a mixture of different adhesives. The adhesive composition may further include a solvent, such as acetone, water, an alcohol, particularly methanol, ethanol, iso-propanol, propanol, butanol, pentanol or hexanol, dichloromethane, hydrocarbons, particularly pentane, hexane, heptane, octane, nonane or decane, or any mixtures and/or isomers thereof. In a typical embodiment, the at least one adhesive forms a solution, suspension or emulsion with the solvent, preferably a solution.

One advantage of using a mixture of adhesives is that it allows different properties of different adhesives to be combined with each other. These properties may include any one or any combination of the following: fast binding, strong binding, flexibility after binding, rigidity after binding, cost, environmental footprint, commercial availability and natural availability. As an example, using a defined mixture of two adhesives may allow the advantageous binding properties of one of the adhesives to be combined with the low cost and/or high availability of the other adhesive.

Adhesive as used herein refers to a non-metallic substance binding cellulosic raw material together. The binding preferably includes covalent bonds formed by cross-linking of the adhesive, such as on exposure to a high temperature and/or pressure. The covalent bonds are formed between molecules from the adhesive and may additionally include covalent bonds between the adhesive and the cellulosic raw material. In typical embodiments, the covalent bonds include any one or any combination of the following bonds: ester, amide, ether, C—C bond, carbamate, carbonate, carbamide, sulfoxide, sulfonyl and sulfonic ester. In further embodiments, the binding may include non-covalent bonds, such as but not limited to ionic bonds, hydrogen bonds, halogen bonds, van der Waals forces, hydrophobic effects and 7-effects.

The binding of the cellulosic raw material together using the adhesive composition includes, in a first step, bringing the cellulosic raw material into contact with the adhesive composition, and, in a subsequent second step, hardening. The hardening may include a chemical reaction of the adhesive (i.e. “reactive”) or may be non-reactive. The cellulosic raw material may be brought into contact with the adhesive composition by several means, including but not limited to: spraying, applying, filming, mixing, such as stirring or shaking, brushing or rolling. The bringing into contact may include bringing at least a part of the surface area or the entire surface area of the cellulosic raw material into contact with the adhesive composition. Additionally or alternatively, the adhesive composition may be soaked into the cellulosic raw material.

In a preferred embodiment, the bonding of the adhesive includes a highly branched network of covalent bonds formed at least partly by condensation reactions. The adhesive composition preferably includes polyphenols. The condensation reactions result in formation of a polymeric three-dimensional matrix. The matrix may optionally be covalently bound to the cellulosic raw material, such as the cellulosic fibers. The matrix contributes to advantageous physical and/or mechanical properties, such as high stability, high tensile strength and high bending strength.

One function of the matrix is to hold the cellulosic fibers together. Another function of the matrix is to protect the fibers from the environment. The matrix further acts as a medium that distributes a load which is applied to the compressed cellulosic fiber product to a reinforcing phase which includes the cellulosic fibers.

The adhesive composition may optionally additionally include co-reactants and/or hardeners. Hardeners include formaldehyde or derivatives or surrogates thereof, such as trioxane, paraformaldehyde, urea-formaldehyde or hexamethylenetetramine (hexamine), furfuryl alcohol and polymeric diphenylmethane diisocyanate (MDI).

Hardeners, such as formaldehyde or derivatives or surrogates thereof are known to enhance cross-linking of adhesives, in particular cross-linking of tannins, such as condensed tannins. Accordingly, the addition of formaldehyde or derivatives or surrogates, such as hexamine, is advantageous as it increases at least some physical and/or mechanical properties, such as increasing the stability, tensile strength and bending strength.

In some embodiments, the adhesive composition comprises a first fraction and a separate second fraction. In a typical embodiment, the second fraction of the adhesive composition is separated from the first fraction of the adhesive composition by a physical barrier, such as a wall. As an example, the first and second fraction of the adhesive composition may be contained in different containers, which may e.g. be connected to air nozzles. The first fraction of the adhesive composition and second fraction of the adhesive composition may also be separated by an interface layer positioned between the first fraction of the adhesive composition and the second fraction of the adhesive composition. In a typical embodiment, the first fraction of the adhesive composition is made of at least 90 wt-%, particularly at least 95 wt-%, more particularly at least 98 wt-%, tannin solution and the second fraction of the adhesive composition is made of at least 90 wt-%, particularly at least 95 wt-%, more particularly at least 98 wt-%, hardener solution, particularly hexamine solution. In some embodiments, the first fraction of the adhesive composition consists of a 40 wt %-50 wt % solution of tannins in water and the second fraction of the adhesive composition consists of a 35 wt %-45 wt %, particularly 40 wt %, solution of hexamine in water. In some embodiments, the dry weight ratio of the hexamine and tannin is between 1:19 and 1:10, preferably 1:13.

In some embodiments, the adhesive composition is essentially free of co-reactants and/or hardeners. In preferred embodiments, the adhesive composition is essentially free of formaldehyde or derivatives or surrogates thereof. Essentially free means that the content of formaldehyde or derivatives or surrogates thereof in the adhesive composition is less than 3 wt-%, such as below 1 wt-%, in particular below 0.1 wt-%, preferably 0 wt-%. It is one advantage of these embodiments that no hazardous chemicals such as formaldehyde or volatile organic compounds (VOCs) are emitted during the production process. A further advantage is that the adhesive, co-reactant and hardener have a benign environmental impact as they are not petroleum-based.

The raw mass as used herein derives from the cellulosic raw material. In some embodiments, it is pliable. In a typical embodiment, the raw mass includes a mixture of the cellulosic raw material with the adhesive composition. The raw mass may further include additives such as hydrophobic and/or mineral additives. In further embodiments, the raw mass is essentially free of hydrophobic and/or mineral additives. Essentially free means that the content of hydrophobic and/or mineral additives is less than 5 wt %, preferably less than 1 wt %. In some embodiments, the raw mass consists of the cellulosic fibers, pith and the adhesive composition.

Compressing the raw mass as used herein includes subjecting the raw mass to a physical pressure, such as using a press. Compressing may further include at least temporarily varying the temperature.

Condensation refers to a chemical reaction during which water is lost. In particular, two molecules may react to form a product and at least one molecule of water.

The general objective of this disclosure is achieved in a second aspect of the invention by a compressed cellulosic fiber product manufactured from cellulosic raw material by the process according to the invention, wherein the compressed cellulosic fiber product has a density between 600 and 900 kg/m³, preferably between 700 and 800 kg/m³, more preferably 750 kg/m³. The density of the compressed cellulosic fiber product may be determined by standard processes known to the skilled person, such as according to DIN EN 323: 1993-08 and DIN EN 326-1:1994. The mass and the volume of a given test piece are measured at the same moisture content of the test piece.

### BRIEF DESCRIPTION OF THE FIGURES

FIG. 1 shows the cutting pattern used for the 400 mm×400 mm fiberboard and for the 340 mm×340 mm fiberboard.

FIG. 2 shows the bending test setup according to DIN EN 310 (1993).

### DETAILED DESCRIPTION OF THE INVENTION

In some embodiments, the cellulosic raw material derives from coconut husk, rice husk, wheat straw, rice straw, bagasse, hemp, kenaf, preferably coconut husk. The listed cellulosic raw materials share at least some physical and chemical properties that make them particularly suitable cellulosic raw materials to be used in the disclosed manufacturing process. The physical and chemical properties include tensile strength, elongation, density, water absorption, hemicellulose content, cellulose content and lignin content.

It is a further advantage of using the listed cellulosic raw materials, that they are typically obtained as by-products from producing the corresponding fruit or vegetable.

Husk, as used herein, refers to the outer shell, coating or covering of a grain, seed, fruit or vegetable. Husk, as used herein, originates from plants. Husk is typically dry and is typically low in nutrients. Low in nutrients means essentially free of nutrients. Essentially free of nutrients means that the husk contains less than 10 wt-%, particularly less than 5 wt-%, in particular less than 2 wt-% nutrients. Nutrients, as used herein, are substances that provide nourishment essential for the maintenance of humans and for growth. In particular, nutrients, as used herein, include vitamins, carbohydrates, lipids and proteins that can be readily taken up and metabolized by humans. In particular, nutrients do not include cellulose, lignin and lignocellulose. Husk typically has a structural and/or protective function for its grain, seed, fruit or vegetable. It is typically a by-product from grain, seed, fruit or vegetable production. The husk, as used in the disclosed process, is essentially free of its grain, seed, fruit or vegetable. Essentially free means that the grain, seed, fruit or vegetable has been separated from its husk in customary or commercial processes, which are typically aimed primarily at the production of the grain, seed, fruit or vegetable. In some embodiments, essentially free means less than 10 wt-%, such as less than 5 wt-%, particularly less than 2 wt-%, relative to the weight of the husk. In preferred embodiments, essentially free means 0 wt-% of the husk.

Coconut, as used herein, refers to plants from the genus Cocos, particularly to plants from the species Cocos nucifera (coconut tree). In preferred embodiments coconut refers to the botanical varieties Laguna Tall, Tambali, Laguna Bill, Green Dwarf.

Coconut husk refers to the fibrous material between the hard, internal shell and the outer coat of a coconut. Coconut husk comprises coconut fibers (also referred to as coir) and coconut pith (also referred to as coir peat).

Rice husk (also called rice hulls) refers to the protecting covering of grains of rice. The protective covering is typically hard. Rice, as used herein, refers to the seed of the grass species Oryza sativa (commonly known as Asian rice) or the grass species Oryza glaberrima (commonly known as African rice).

Wheat straw refers to the straw of wheat, which refers to the dry stalks of the wheat plant obtained after removal of the grain and the chaff. Wheat, as used herein, refers to plants belonging to the genus Triticum within the family poaceae. In particular, wheat includes common wheat (T. aestivum).

Rice straw refers to the straw of rice, which refers to the dry stalks of the rice plant obtained after removal of the grain and the chaff.

Bagasse refers to the dry fibrous material that remains after crushing sugarcane or sorghum stalks to extract their juice. Sugarcane, as used herein, refers to Saccharum officinarum, which is a perennial grass of the family poaceae, as well as hybrids of this species.

Hemp, as used herein, refers to plants belonging to the family Cannabaceae, genus Cannabis, and species C. sativa.

Kenaf, as used herein, refers to plants form the family Malvaceae, such as plants from the genus Hibiscus, particularly plants from the species H. cannabinus.

In some embodiments, the cellulosic raw material is husk-derived raw material. Husk-derived raw material, as used herein, derives from plants. Husk-derived raw material includes the husk itself as well as products arising from processing of the husk, wherein the processing includes any one or any combination of the following: sawing, crunching, milling, cutting, shredding, grinding, grounding and milling.

In some embodiments, the cellulosic raw material further comprises pith. Pith refers to spongy, soft cellular tissue of plants. In certain plants, pith refers to the soft cellular tissue in the core area of the plant's shoot axes. In other plants, such as coconut, pith refers to the soft cellular tissue comprised in the coconut husk. In coconut, the fibers comprised in the coconut husk are embedded in pith.

The ratio of cellulosic fibers to pith can be in the range of 3-7 to 7-3, i.e. 30%-70% cellulosic fibers (by weight) relative to 70%-30% pith (by weight).

In some embodiments, the ratio of cellulosic fibers to pith is in the range of 3-5 to 7-5, e.g. 3.5-4.5 to 5.5-6.5, particularly 4 to 6. The ratio refers to weight. In some embodiments, the ratio of cellulosic fibers to pith is approximately 60% pith and 40% cellulosic fiber. In some embodiments, the ratio by weight of cellulosic fibers to pith is 40%-60%, particularly 50%, pith and 60%-40%, particularly 50%, cellulosic fibers. In further embodiments, the cellulosic raw material comprises 40 wt-%-60 wt-%, particularly 46 wt-%-54 wt-%, more particularly 50 wt-%, pith and 60 wt-%-40 wt-%, particularly 54 wt-%-46 wt-%, more particularly 50 wt-%, cellulosic fibers. In further embodiments, the cellulosic raw material consists of 40 wt-%-60 wt-%, particularly 46 wt-%-54 wt-%, more particularly 50 wt-%, pith and 60 wt-%-40 wt-%, particularly 54 wt-%-46 wt-%, more particularly 50 wt-%, cellulosic fibers.

One advantage is that the use of the above mentioned ratio leads to compressed cellulosic fiber products, such as fiberboards, which have advantageous mechanical and physical properties. The advantageous mechanical and physical properties include resistance to decay or degradation by insects and fungi, strong internal bonding and low thickness swelling properties. A further advantage of the embodiments is that pith is frequently an undesired side-product which is generally regarded as industrial waste, which needs to be disposed of. By employing pith cellulosic raw material, the environmental impact is alleviated.

In some embodiments, the husk is processed to provide cellulosic fibers and pith separately. This means that after processing of the husk, the cellulosic fibers and pith are separate from each other, typically separated by a physical barrier such as a wall. It is understood that, under practical conditions, the separated cellulosic fibers may still include minor amounts of pith, preferably less than 10%, more preferably less than 5%, more preferably less than 2%, of the weight of the separated cellulosic fibers. Conversely, it is understood that, under practical conditions, the separated pith may still include minor amounts of cellulosic fibers, preferably less than 10%, more preferably less than 5%, more preferably less than 2%, of the weight of the separated pith. In some embodiments, the cellulosic fibers and pith may subsequently be mixed together in a predetermined ratio, such as 40%-60%, particularly 50%, pith and 60%-40%, particularly 50%, cellulosic fiber. In these embodiments, the cellulosic raw material may comprise 40%-60%, particularly 50%, pith and 60%-40%, particularly 50%, cellulosic fibers. One advantage of these embodiments is that they lead to compressed cellulosic fiber products with advantageous physical properties, mechanical properties and/or aesthetic properties.

In some embodiments, the husk is processed to provide the cellulosic raw material comprising cellulosic fibers and pith in the ratio of approximately 60% pith and 40% cellulosic fiber. In particular, coconut husk and coconut pith are typically provided in this ratio when coconut husk is processed by hammer-milling or pulverizing. These embodiments are particularly advantageous because they do not require the cellulosic fibers and the pith to be separated after processing, such as processing of the husk. This saves time and money.

In some embodiments, the step of providing the cellulosic raw material includes shredding a husk, such as a coconut husk, into chips, following by milling of the chips. In a typical embodiment, the chips have a length of 1-20 cm, preferably 3-12 cm, and a width of 1-8 cm, preferably 3-4 cm. The milling is preferably hammer-milling and is preferably performed with a 5 mm screen. The fibers and pith obtained after milling may either be used directly as cellulosic raw material or may first be sieved, preferably using a 0.2-0.5 mm sieve, to obtain the cellulosic raw material. Sieving ensures that fine material is removed, which enhances the physical properties of the compressed cellulosic fiber product.

In some embodiments, the step of providing the cellulosic raw material includes separating cellulosic fibers and pith. The separation may, for example, be realized in a separate operation, typically starting from a mixture of cellulosic fibers and pith produced in a separate step. The separation may also be realized in a single operation together with producing the fibers and pith, such as from husk, such as coconut husk. It is understood that, under practical conditions, after separation, the separated cellulosic fibers may still include minor amounts of pith, preferably less than 10%, more preferably less than 5%, more preferably less than 2%, of the weight of the separated cellulosic fibers. Conversely, it is also understood that, under practical conditions, after separation, the separated pith may still include minor amounts of cellulosic fibers, preferably less than 10%, more preferably less than 5%, more preferably less than 2%, of the weight of the separated pith. In some embodiments, the separated cellulosic fibers obtained are shortened to a length of 0.3-4 cm, preferably 0.5-2 cm. The separated cellulosic fibers may, for example, be shortened using a guillotine cutting machine, a shredding mill, a hammer mill or a knife mill. The resulting cellulosic fibers and, optionally, the separated pith may subsequently be used directly as cellulosic raw material, preferably as first fraction of the cellulosic raw material and second fraction of the cellulosic raw material, respectively. Alternatively, after shortening, the resulting separated cellulosic fibers may be sieved, preferably using a 0.2-0.5 mm sieve, and subsequently be used as cellulosic raw material, preferably as first fraction of the cellulosic raw material. Sieving ensures that fine material and small particles are removed, and that only the coarser material is kept, which enhances the physical properties of the compressed cellulosic fiber product. In some embodiments, the separated pith is (also) sieved, preferably using a 0.2-0.5 mm sieve, and subsequently used as cellulosic raw material, preferably as second fraction of the cellulosic raw material.

In some embodiments, the cellulosic raw material comprises a first fraction and a separate second fraction. In a typical embodiment, the second fraction of the cellulosic raw material is separated from the first fraction of the cellulosic raw material by a physical barrier, such as a wall. As an example, the first and second fraction of the cellulosic raw material may be contained in different containers. The first fraction of the cellulosic raw material and second fraction of the cellulosic raw material may also be separated by an interface layer positioned between the first fraction of the cellulosic raw material and the second fraction of the cellulosic raw material. In a typical embodiment, the first fraction of the cellulosic raw material is made of at least 90 wt-%, particularly at least 95 wt-%, more particularly at least 98 wt-%, cellulosic fibers and the second fraction of the cellulosic raw material is made of at least 90 wt-%, particularly at least 95 wt-%, more particularly at least 98 wt-%, pith. In some embodiments, the ratio by weight of the first fraction of the cellulosic raw material and the second fraction of the cellulosic raw material is 40-60: 60-40, preferably 45-55: 55-45, more preferably 50: 50.

In some embodiments, during the step of treating the cellulosic raw material with the adhesive composition, the first fraction of the cellulosic raw material and second fraction of the cellulosic raw material are separately treated with the adhesive composition. The first fraction and second fraction of the cellulosic raw material may subsequently be combined to obtain the raw mass. As an example, the first fraction of the cellulosic raw material may be contained in a first container and treated with a first portion of the adhesive composition in this first container, and the second fraction of the cellulosic raw material may be contained in a second container which is separate from the first container, wherein the second fraction of the cellulosic raw material is treated with a second portion of the adhesive composition in the second container. The first and second container may, for example, be separated by a physical barrier, such as a wall. In a further example, the first fraction of the cellulosic raw material is pre-treated with the adhesive composition to give a pre-mixture, and the second fraction of the cellulosic raw material is subsequently treated with the pre-mixture. In these embodiments, the adhesive composition typically comprises a tannin solution, preferably in water. As an example, the adhesive composition may consist of a tannin solution. As a further example, the adhesive composition may consist of tannin, hexamine and water, wherein preferably, the dry weight ratio of hexamine and tannin is between 1:19 and 1:10, particularly 1:13. The adhesive composition may, in some embodiments, consist of the first and second portion. The first and second portion of the adhesive composition may, for example, be separated by a physical barrier, such as a wall. The first portion and the second portion of the adhesive composition may have essentially the same composition. The composition refers to the relative amounts of the components included in the adhesive composition. As an example, the first and second portion of the adhesive composition may comprise a tannin solution. As a further example, the first and second portion of the adhesive composition may comprise water, tannin and hexamine. The first and second portion of the adhesive composition may have essentially the same mass or may have a different mass. As an example, the adhesive composition may be split into a first and second portion either essentially evenly or unevenly.

In some embodiments, during the step of treating the cellulosic raw material with the adhesive composition, the adhesive composition is added batchwise or portionswise to the cellulosic raw material. In some embodiments, the adhesive composition is added continuously to the cellulosic raw material, such as through a nozzle, e.g. an air nozzle. In some embodiments, the step of treating the cellulosic raw material with the adhesive composition includes pre-treating the cellulosic raw material with a first fraction of the adhesive composition to give a pre-raw mass and, subsequently, treating the pre-raw mass with a second fraction of the adhesive composition. The first and second fraction of the adhesive composition may, for example, be applied to the cellulosic raw material through a first and second nozzle, respectively. In some embodiments, the first and second nozzle are air nozzles. The embodiments described in this paragraph are independent of the embodiments described in the previous paragraph. This means that the embodiments described in the previous paragraph and the embodiments described in this paragraph may be combined with each other. In particular, the first portion of the adhesive composition and the second portion of the adhesive composition may each comprise a first and second fraction. In other words, the adhesive composition may comprise a first fraction of a first portion, a second fraction of a first portion, a first fraction of a second portion and a second fraction of a second portion.

One advantage of these embodiments is that the ratio of cellulosic fibers to pith may be easily adjusted and optimized, which in turn results in optimized physical properties of the resulting compressed cellulosic fiber products. A further advantage is that by separately treating the first and second fraction of the cellulosic raw material with the adhesive composition, better resination is achieved, particularly better resination of the cellulosic fibers, which leads to enhanced physical properties of the resulting compressed cellulosic fiber products. In advantageous embodiments, the adhesive composition is more evenly distributed over the surface of cellulosic raw material. A further advantage is that the physical properties of the compressed cellulosic fiber products may be easily optimized by increasing the number of variables in the manufacturing process.

In some embodiments, the cellulosic raw material further comprises a filling material. Filling material may include small particles, a powder, dust or small fibers. The small particles included in the filling material have a diameter of less than 5 mm, preferably less than 3 mm, in particular less than 2 mm. The small fibers have a length of less than 4 cm, preferably less than 3 cm, and have a diameter of less than 3 mm, preferably less than 1 mm, in particular less than 0.5 mm. In some embodiments, the filling material is wooden. In some embodiments, the filling material is comprised in the first fraction of the cellulosic raw material or second fraction of the cellulosic raw material. In other embodiments, the filling material is comprised in equal amounts by weight in the first fraction of the cellulosic raw material and the second fraction of the cellulosic raw material.

In further embodiments, the cellulosic fibers have a length of 4-5 cm, preferably 3-2 cm, and a diameter of 5-40 microns, preferably 10-25 microns. In further embodiments, the cellulosic fibers have a length of 0.3 cm-5 cm, preferably 0.5 cm-2 cm. These lengths are particularly advantageous for the production of compressed cellulosic fiber products, such as fiberboards, as they lead to advantageous physical properties, mechanical properties and/or aesthetic properties. In particular, the bending properties (Bending Strength and Modulus of Elasticity) are advantageous. One advantage of these embodiments is that the cellulosic fibers may be easily provided by using a hammer-mill or a pulverizer, both of which are widely available.

In some embodiments, the step of providing cellulosic raw material includes one or any combination of the following: shredding, sieving, milling, cutting, grinding, pounding, crushing, kibbling and crunching, preferably milling. The milling may, for example, be carried out using a hammer mill, or a vertical hammer mill (decorticating machine) or double stream mill.

In some embodiments, the fibers from which the husk-derived raw material is provided have a length of 5-25 cm, e.g. 10-15 cm. In particular, if coconut husk fibers are used as feedstock for providing the husk-derived raw material, the coconut husk fibers preferably have a length of 5-25 cm, e.g. 10-15 cm.

In some embodiments, the adhesive composition includes tannins, preferably condensed tannins. In some embodiments, the tannins are derived from quebracho wood (Schinopsis Iorentzii and Schinopsis balansae), mimosa bark (Acacia meamsii), grape seeds (Vitis vinifera), pine bark, spruce bark or mangium bark (Acacia mangium), preferably from quebracho wood or mimosa bark. The adhesive composition may include at least one tannin or any mixture of tannins.

The use of tannins from quebracho wood or mimosa bark is particularly advantageous because they are widely commercially available and relatively cheap compared to most other tannins. Additionally, quebracho wood and mimosa bark are widespread in nature and therefore available in different regions and countries. Additionally, the mechanical and physical properties of the molded wooden products, such as fiberboards produced using tannins from quebracho wood and/or mimosa bark are particularly advantageous. The advantageous mechanical and physical properties include water resistance and resistance to decay or degradation by insects and fungi.

Tannins are a class of polyphenolic biomolecules with a molecular weight typically ranging between 300 and 20′000, in particular between 500 and 5′000. Tannins are typically astringent and bitter-tasting. Tannins occur naturally in various vegetative materials, such as barks and woods. Tannins are mainly present in soft tissues of a plant, such as sheets, needles or bark. Historically, the term “tannin” indicated a plant material which allows the transformation of hide into leather.

Tannins may be categorized into three different classes: hydrolysable tannins, complex tannins and condensed tannins. Hydrolysable tannins include a mixture of phenols such as ellagic acid and gallic acid, esters of sugars (i.e., glucose), gallic acid or digallic acid.

Complex tannins include structures formed from an ellagitannin unit and a flavan-3-ol unit. As an example, acutissimin A is a complex tannin. Condensed tannins are polyphenolic. They typically include 3-8 flavonoid repetition units. Each flavonoid repetition unit comprises two phenolic rings. The flavonoid repetition units are typically derived from flavan-3-ol and flavan-3,4-diol. The flavonoid units are generally linked by C—C bonds and are thus not susceptible to cleavage by hydrolysis. The skilled person knows that the exact process by which the plant is prepared and extracted influences the composition of the extracted tannin. In one out of many different processes, the plant is first dried, followed by milling and homogenizing of the plant. Condensed tannins are typically essentially free of sugar. Essentially free means that the sugar content by weight is less than 10%, e.g. less than 5%, particularly less than 1%. In some embodiments, essentially free means that the sugar content is 0%.

Different tannins are commercially available in different forms, including as powders.

In some embodiments, the adhesive composition includes a solution of tannin or tannins, preferably condensed tannins, in water. The adhesive composition may, for example, include a 40 wt %-50 wt % solution of tannins in water. In further embodiments, the adhesive composition additionally includes formaldehyde or a derivative or surrogate thereof, particularly hexamine.

The adhesive composition may be provided in different ways. As an example, where the adhesive composition comprises tannins, the solution of tannins in water may, for example, be prepared by stirring (such as at 1000 rpm) a mixture of the respective tannin, such as in the form of a powder, with water at room temperature for at least 7 minutes. Optionally, a hexamine solution, such as an aqueous hexamine solution, preferably with a concentration of 40% (w/w) hexamine in water, may be added to the solution of tannins. The resulting mixture may be passed through a fine strainer. In further embodiments, additives may additionally be added to the mixture before or after stirring, such as hydrophobic and/or mineral additives. In some embodiments, a solution or emulsion of tannins in a solvent, such as water, is used.

In some embodiments, the adhesive composition includes 30-55 wt-%, preferably 37-46 wt-%, such as 37 wt-%, of tannin. In some embodiments, the adhesive composition includes 40-70 wt-%, preferably 50-60 wt-%, such as 50 wt-%, water. In further embodiments, the adhesive composition includes 2-4 wt-%, preferably 2.6-3.2 wt-%, such as 3 wt-%, hexamine. As an example, the adhesive composition may include 37-46 wt-% tannin, 50-60 wt-% water and 2.6-3.2 wt-% hexamine.

In some embodiments, in addition to the solution of tannins, the adhesive composition includes hexamine, preferably an aqueous hexamine solution, preferably with a concentration of 40% (w/w) hexamine in water. The dry weight ratio of tannin and hexamine may be between 5% and 9%, preferably 7% (w/w). In other words, the dry weight ratio of hexamine and tannin may be between 1:19 and 1:10, preferably 1:13. One advantage of these embodiments is that the compressing time required to obtain the compressed cellulosic fiber product is reduced. Additionally, the resulting compressed cellulosic fiber product displays better mechanical properties and lower thickness swelling.

Tannins, particularly condensed tannins, may undergo condensation reactions, particularly autocondensation reactions, which leads to cross-linking to form a three-dimensional polymeric matrix and thus leads to hardening. The condensation reaction, particularly autocondensation reaction, may be accelerated by different catalysts, including Lewis and/or Bronsted acids, such as silicates or derivatives thereof. Additionally, the condensation reaction, particularly autocondensation reaction, may be accelerated in the presence of cellulose and/or lignocellulose.

Autocondensation, as used herein, denotes a condensation reaction between two molecules that are substantially identical. Substantially identical includes molecules with identical structures and identical structural units. In other words, substantially identical includes oligomers of a different size but composed of the same monomer(s).

In some embodiments, the step of treating the cellulosic raw material with an adhesive composition includes blending the cellulosic raw material with the adhesive composition, preferably using a rotary tumble blender or a rotary continuous mixer. The rotary tumble blender is preferably used on a laboratory scale and the rotary continuous mixer is preferably used on an industrial scale. In some embodiments, the blending using the rotary tumble blender is carried out for 5 minutes at 100 rpm. Blending the cellulosic raw material with the adhesive composition using a rotary tumble blender is particularly advantageous as it ensures uniform distribution of the adhesive composition over the surface of the cellulosic raw material, which results in advantageous physical and/or mechanical properties.

In further embodiments, the adhesive composition is sprayed into the rotary tumble blender or the rotary continuous mixer through a spray nozzle. The skilled person recognizes that the blending time depends on the scale and the machine used for blending. In some embodiments performed on a laboratory scale, the blending time is 5-10 minutes, such as 7 minutes.

In further embodiments, the step of treating the cellulosic raw material with an adhesive composition includes bringing the cellulosic raw material into contact with the adhesive composition, which may include applying the adhesive composition to the surface of the cellulosic raw material. The adhesive composition may be applied to either part of the surface of the cellulosic raw material or substantially the entire surface. The application may, for example, include spraying and/or brushing.

In some embodiments, the step of treating the cellulosic raw material with an adhesive composition further includes adjusting the pH of the mixture. In further embodiments, the pH of the adhesive composition is between 4 and 5. In further embodiments, the pH of the adhesive composition is in the range of 5-7. A pH in the range of 5-7 may, for example, be realized by addition of hexamine, e.g. as part of the adhesive composition. Both of these pH ranges are advantageous as they ensure rapid and high-yielding autocondensation of the adhesive, which leads to advantageous physical and/or mechanical properties, such as high stability, high tensile strength and high bending strength.

The step of treating the cellulosic raw material with an adhesive composition is typically carried out at room temperature.

Step iii) includes compressing the raw mass in a pre-defined form. In some embodiments, this pre-defined form is in accordance with a final target shape of the compressed cellulosic fiber products. As an example, the pre-defined form might be essentially complementary to the target shape of the compressed cellulosic fiber product. In this embodiment, the pre-defined form must be essentially fully filled with the raw mass in order for the resulting compressed cellulosic fiber product to have the final target shape.

In other embodiments, the pre-defined form does not have to be essentially fully filled with the raw mass. Even if the pre-defined form is not essentially fully filled with the raw mass, it may still influence the shape of the resulting compressed cellulosic fiber product such that it approximates the final target shape. In yet another embodiment, the pre-defined form acts primarily as a structural delimitation of the raw mass during the compression. As the compression step iii) includes pressing of the raw mass, the pre-defined form may delimit the material to a confined volume or space, which is then decreased as part of the compression. One advantage of this embodiment is that it is not necessary that the pre-defined form is essentially fully filled during the compression, which saves manufacturing time.

The final target shape of the compressed cellulosic fiber product includes the desired three-dimensional structure of the compressed cellulosic fiber product. In other words, it includes the three-dimensional structure which the compressed cellulosic fiber product is envisioned or planned to have after its production. The final target shape may, for example, be given as a three-dimensional structure, such as a CAD structure using, for example, AutoCAD.

In some embodiments, the step of compressing the raw mass includes the steps of: iii.a) preforming the raw mass and iii.b) hot-compressing the preformed raw mass to obtain the compressed cellulosic fiber product. In further embodiments, the step of hot-compressing the preformed raw mass is performed at 150-220° C., preferably 170-200° C., more preferably 180° C. In some embodiments, the step of preforming the raw mass is performed at room temperature. The skilled person understands that the room temperature depends on various factors, including the region or country where the production is carried out. In particular, room temperature refers to 15-40° C., preferably 20-30° C. One advantage of these embodiments is that they lead to compressed cellulosic products, particularly fiberboards, which have advantageous physical and mechanical properties.

Preforming of the raw mass as used herein refers to bringing the raw mass into a preform. The preform is a geometric form or shape that is compatible with the machine used for carrying out the subsequent step of (iii.b) hot-compressing the preformed raw mass. In other words, the preforming step allows the raw mass to be successfully fed to the machine or unit used for carrying out the hot-compressing step. One advantage of these embodiments is that the preforming of the raw mass allows the subsequent step iii.b) to be carried out quickly as a result of the compatibility of the geometric form or shape of the preform with the machine used for carrying out step iii.b). This saves time and energy, in particular in the typical cases where step iii.b) is more energy-costly than step iii.a).

The structural integrity of the preformed raw mass is typically low compared to the compressed cellulosic fiber product. It is typically sufficient for the structural integrity of the preformed raw mass to be high enough to prevent complete collapse or disintegration of the preformed raw mass before the hot-compressing step.

The structural integrity of a material is low if the material cannot withstand a small structural load, such as a weight or force, without a significant change in its shape, form or structure.

The form and/or shape of the preform raw mass may but does not have to be essentially identical to the form and/or shape of the compressed cellulosic fiber product. It is also possible that the form and/or shape of the preformed raw mass is significantly different from that of the compressed cellulosic fiber product.

In some embodiments, the preformed raw mass is a mat, in particular a cold-pressed mat. These embodiments are particularly suitable for the production of fiberboards. Cold-pressed means that the mat has been pressed without additional heating, particularly that it has been pressed at room temperature. A mat refers to a material with a loosely defined structure, shape and/or volume. A mat has a top surface and a bottom surface opposite the top surface, which are each defined by a length and a width. The top surface and the bottom surface are typically similar in size. The top and bottom surface of the mat are separated by a thickness, which does not have to be uniform along with width and/or length of the mat. The thickness, or the average thickness, are significantly smaller than the length and width of the mat. The cold-pressed mat typically does not have a high structural integrity. In particular, the subsequent hot-compressing leads to an increase in structural integrity, among other things by virtue of binding of the adhesive.

In some embodiments, the mat, such as the cold-pressed mat, has a thickness of 3-10 cm, particularly 4-6 cm. In further embodiments, the mat, such as the cold-pressed mat, has a thickness of 5-30 cm, such as 10-20 cm, particularly 15 cm. This embodiment is particularly advantageous on a laboratory scale as it is compatible with a wide range of widely available machines suitable for carrying out the hot-compressing step iii.b).

The specific conditions for the two steps iii.a) and iii.b) depends on various factors, including the scale. The two steps iii.a) and iii.b) may be carried out in a continuous in-line process, in particular on an industrial scale. For an exemplary application, typically performed on a laboratory scale, the temperature applied during the hot-compressing step is applied for 25-55, such as 35-45 seconds per mm hot-compressing thickness. The hot-compressing thickness is the thickness of the mold, form, shape or caste used for the hot-compressing step. In some embodiments in which a temperature of 180° C. is applied and the hot-compressing thickness is 10 mm, the temperature is therefore typically applied for 42-48 sec/mm. In further embodiments, typically performed on a laboratory scale, the temperature applied during the hot-compressing step is applied for 10-25 seconds per mm hot-compressing thickness. In embodiments in which a temperature of 180° C. is applied and the hot-compressing thickness is 10 mm, the temperature is therefore typically applied for 13-19 sec/mm. One advantage of these embodiments is that the short pressing time is associated with reduced energy consumption, which translates into reduced production cost.

The pressure applied during the preforming step iii.a) and the hot-compressing step iii.b) influences the density of the preformed raw mass and the compressed cellulosic fiber product, respectively. In some embodiments, the pressure applied during the hot-compressing step is 400-600 N/cm², such as 450-550 N/cm². This pressure typically yields compressed cellulosic fiber products with a density of 700-800 kg/m³, in particular 750 kg/m³.

The skilled person recognizes that the size of the mold, form, shape or caste used for the step of compressing the raw mass (iii), the temperature and the pressure are each interrelated with each other. This means that different combinations of settings of individual parameters are possible in order to obtain compressed cellulosic fiber products with essentially identical mechanical properties. In particular, the use of an increased pressure during the hot-compressing step may, for example, allow a lower temperature to be applied during this step or may allow the pressure to be applied for a shorter period of time. Consequently, depending on the scale and the availability of machines, parameters developed on a laboratory scale may, for example, be used to derive parameters for use on an industrial scale. The expert knowledge enables the skilled person to derive parameters for use on an industrial scale.

Although the production capacity is obvious dependent, among other things, on the number of machines available, laboratory scale typically refers to the production of roughly 5-8 compressed cellulosic fiber products, particularly fiberboards, per day, while industrial scale typically refers to the production of 3000-4000, or up to 30 000 compressed cellulosic fiber products, particularly fiberboards, per day.

The preforming step iii.a) is typically carried out at room temperature. On industrial scale, the preforming step iii.a) step may include providing the raw mass into a preform. The provision may include spreading the raw mass into the preform, particularly into a uniform, homogeneous preform, either mechanically or with the help of a wind blower for example using a multi-head mat-forming machine. The spread raw mass may then optionally be divided into different portions. The division may include cutting and/or sawing the spread raw mass. The different portions are advantageously chosen in accordance with the hot-compressing step iii.b), such that they are compatible with the machine or unit used for carrying out the hot-compressing step iii.b).

In some embodiments, the preformed raw mass is carried out at atmospheric pressure. In other words, no pressure is applied to the raw mass during step iii.a) in these embodiments. The raw mass may be preformed by filling it into a preform. In one embodiment, the raw mass is preformed on a conveyor belt, wherein the conveyor belt is operationally connected to the machine used for carrying out the hot-compressing step iii.b). In this embodiment, the conveyor belt is used for transporting the preformed raw mass to the machine used for step iii.b). It is one advantage of this embodiment that the preformed raw mass does not need to have a high structural integrity. This means that the technical requirements for the preforming step are lowered. As an example, it is typically sufficient to carry out the preforming step at atmospheric pressure, without application of a pressure. This saves costs and reduces the technical requirements for the machines involved.

In some embodiments, a pressure is applied to the raw mass during the preforming step iii.a). One advantage of this is that it increases the structural integrity of the preformed raw mass, which facilitates its transfer or transport to the machine or unit used for carrying out the hot-compressing step iii.b). Typically, application of a pressure is advisable on laboratory scale but not necessary on an industrial scale. On an industrial scale, the preforming step iii.a) may be carried out by a continuous in-line process in which the transfer of the preformed raw mass poses minimal requirements on the structural integrity of the preformed raw mass.

In some embodiments, the compressed cellulosic fiber product is a fiberboard. In some embodiments, the fiberboard has a length of 300-500 mm, particularly 400 mm, a width of 300-500 mm, particularly 400 mm, and a thickness of 5-30 mm, particularly 10 mm. Fiberboard, as used herein, refers to a board comprising fibers that derive from cellulosic raw material. The fiberboard optionally also comprises an adhesive. In some embodiments, the fiberboard also includes pith and/or filling material.

In some embodiments, the fiberboard is a medium-density fiberboard (MDF). A medium-density fiberboard (MDF), as used herein, has a density in the range of 600-800 kg/m³, particularly 700-800 kg/m³.

A board includes one top surface and one bottom surface opposite the top surface, which is separated from the top surface by a thickness. The top (respectively bottom) surface is defined by a top length (respectively bottom length) and a top width (respectively bottom width). The top width and bottom width are typically substantially identical, and the top length and bottom length are typically substantially identical. The board further includes four sides. Two of these sides are defined by the thickness, the top length and the bottom length. The other two sides are defined by the thickness, the top width and the bottom width. The top surface and the bottom surface are substantially plane. The thickness is typically substantially uniform over the lengths and widths. The surface area of the top and bottom surfaces are typically substantially identical. The surface area of the top and bottom surface area far exceeds the surface area of any of the four sides of the board. Accordingly, a board is commonly perceived as a thin plane.

In further embodiments, the fiberboard is a wooden fiberboard. Wood includes the fibrous and porous structural tissue found in the stems, roots and branches of trees and woody plants. Wood includes, as some of its major components, cellulose fibers and lignin. The cellulose fibers are typically embedded in a matrix of lignin.

One advantage of using the method disclosed herein for the production of fiberboards is that the resulting fiberboards possess advantageous physical, mechanical and/or aesthetic properties. In particular, the fiberboards typically have a brownish color with a random orientation of fibers on the surface.

Physical and/or mechanical properties include: density, thickness tolerance, internal bond strength, thickness swelling, bending strength, modulus of elasticity, thermal conductivity, fire resistance, airborne sound insulation, water vapor resistance, resistance against decay or degradation insects and fungi and emission of formaldehyde and other VOCs. Aesthetic properties include: a color, a pattern and a gloss.

A further advantage is that the method disclosed herein enables the environmentally friendly and/or local production of the fiberboards where they are further processed. In particular, the method allows the production of compressed cellulosic fiber products, such as fiberboards, in South-East Asian countries.

In some embodiments, the method for producing a compressed cellulosic fiber product further includes an additional post-processing step iv), which includes sanding and/or pruning of the compressed cellulosic fiber product. In some embodiments, at least part of the surface of the compressed cellulosic fiber product is sanded by 0.2-0.8 mm, such as 0.5 mm. In particular, if the compressed cellulosic fiber product is a fiberboard, the sanding may include sanding at least one, preferably both surfaces of the fiberboard by 0.2-0.8 mm, such as 0.5 mm. The two surfaces of the fiberboard are its top and bottom surface. In further embodiments, the four sides of the boards are sanded as well.

In some embodiments, the pruning includes trimming at least part of the compressed cellulosic fiber product in accordance with a target pruning shape. The target pruning shape may, for example, be identical to the final target shape. In some embodiment, in which the compressed cellulosic fiber product is a fiberboard, the pruning includes trimming at least some of the sides of the board, particularly all four sides of the fiberboard. In some embodiments, each one of the four sides is trimmed by 10-100 mm, such as 50 mm.

Trimming includes any one or any combination of cutting, sawing, severing, chopping and splitting, preferably cutting and/or sawing.

One advantage of trimming and/or sawing is that the compressed cellulosic fiber product need not have the final target shape immediately after step iii). Accordingly, it is not required, for example, to fill the pre-defined form, if used, essentially fully with the raw mass. This saves time and cost.

In some embodiments, the compressed cellulosic fiber product disclosed herein has a density between 600 and 900 kg/m³, preferably between 700 and 800 kg/m³, more preferably 750 kg/m³. This density range is advantageous because it strikes a desirable balance between a convenient weight for transportation and/or further processing on the one hand, and sufficient mechanical robustness and stability for indoor and outdoor applications on the other hand, particularly indoor applications.

In some embodiments, the molded cellulosic raw material is a fiberboard. The fiberboard may, for example, derive from coconut husk as cellulosic raw material.

In some embodiments, the fiberboard according to the present disclosure may have any one or any combination of the following physical or mechanical properties:
The tensile strength perpendicular to the plane of the fiberboard (IB) may lie above 0.6 N/mm², preferably between 0.6 and 0.95 N/mm², more preferably between 0.64 and 0.92 N/mm² as determined according to DIN EN 319 (1993);
The modulus of elasticity (MOE) of the fiberboard may lie above 1800 N/mm², preferably between 1800 and 2500 N/mm², more preferably between 2200 and 2500 N/mm² or between 1850 and 2200 N/mm², such as between 1900 and 2100 N/mm² as determined according to DIN EN 310 (1993);
The bending strength (BS) of the fiberboard may lie above 15 N/mm², preferably between 16 and 24 N/mm², such as between 16 and 23 N/mm², more preferably between 17 and 21 N/mm² as determined according to DIN EN 310 (1993);
The thickness swelling (TS, in water for 24 h) of the fiberboard lies below 20%, preferably between 7% and 18%, more preferably between 8% and 15% or between 10% and 16%, as determined according to DIN EN 317 (1993);
The water absorption of the fiberboard lies below 75%, preferably between 50% and 70% or between 60% and 73%, more preferably between 58% and 70%, as determined according to the description.

The values listed above preferably refer to fiberboards with a reference density of 700-800 kg/m 3, in particular 750 kg/m 3. The values of the above-listed parameters for a given reference density may either be determined using a fiberboard which has essentially the reference density, or they may alternatively be determined by extrapolation using a fiberboard which has an off-reference density. The extrapolation includes determining the value of the respective parameter for the fiberboard with the off-reference density. The determined value for the fiberboard with the off-reference density is then adjusted by a factor corresponding to the discrepancy between the off-reference density and the reference density. In one embodiment, the discrepancy is the difference between the off-reference density and the reference density, and the factor corresponding to this discrepancy is the quotient of the off-reference density over the reference density. In a preferred embodiment, the adjustment of the value determined for the fiberboard with the off-reference density includes multiplication of this value with the quotient of the off-reference density over the reference density. The product of this multiplication corresponds to the extrapolated value of the respective parameter for a fiberboard having the reference density.

In an embodiment, the off-reference density of the fiberboard preferably lies within ±20%, particularly 10% of the reference density. This embodiment has the advantage that the extrapolation gives accurate values for the above-listed parameters.

### EXPERIMENTAL DATA

Raw Materials

Cellulosic Raw Material:

Coconut husk from different varieties (Laguna Tall, Laguna Bill, Green Dwarf) of coconut tress (Cocos nucifera) was obtained from the Philippines.

Adhesive Composition:

Tannin, extracted from the bark of mimosa (Acacia mearnsii [De wild.]) and quebracho wood (Schinopsis lorentzii and Schinopsis Balansae), was used as purchased from Silvateam S.p.A. (San Michele Mondovi, Italy).

A solution of tannin in water was prepared as follows: tannin powder (40% w/w) was added under constant stirring (1000 rpm) to warm water (50° C.) until completely dissolved (which typically took at least 5 minutes). The resulting mixture was passed through a fine strainer (mesh size 0.2 mm) and the resulting solution was used as adhesive composition.

Optionally, mineral additives and/or hydrophobic additives were additionally added to the mixture prior to stirring, as described below.

Mineral Additives:

Mineral powders, Calcium Carbonate (CaCO₃), Calcium Carbonate with functional surface additive and Calcium hydroxide (Ca(OH)₂ traditionally called slaked lime) were used as mineral additives as provided by OMYA AG.

The mineral additives were added in either of two different ways. In the first one, 10% (by weight relative to dry tannin) of dry mineral powders (e.g. 10 g mineral powder to 90 g tannin) were added to the mixture of tannin and water before mixing. In the second alternative, 10% (by weight relative to oven dry cellulosic raw material) of dry mineral powders (e.g. 100 g mineral powder to 900 g oven dry cellulosic raw material) were added to the cellulosic raw material during step ii (treating the cellulosic raw material with an adhesive composition).

Hydrophobic Additives:

Virgin coconut oil was used as a hydrophobic additive as provided by Pasciolco Agri Ventures (Quezon, Philippines). Sunflower oil was used as a hydrophobic additive as provided by Migros-Genossenschafts-Bund (Biel, Switzerland). Synthetic paraffin wax blend emulsion HYDROWAX PRO A16 (product number 22377) was used as a hydrophobic additive as provided by SASOL AG.

The hydrophobic additives were added in either of two different ways. In the first one, 0.5% (w/w) hydrophobic additive emulsion, based on oven dry cellulosic raw material weight was added to the mixture of tannin and water before mixing. In the second alternative, a water solution of 20% w/w (hydrophobic additive emulsion to water) were sprayed onto the surfaces of the raw mass and/or the preformed raw mass.

Production

Production step (i) (providing cellulosic raw material):

The following three methods were used to provide the cellulosic raw material:

The coconut husk was milled to the desired size. Different approaches were tried out:
a) Coconuts husk is first cut by hand lever shear metal cutter into small 3-4 cm long and 3-4 cm wide cube chips, followed by hammer milling (using a Friedli Hammermuhle THM-A) with a 5 mm screen. The final material is composed of 1-3 cm long fibres and pith.
b) Involves Step a) plus, as an additional step, passing the material through a 0.5 mm steel woven wire mesh sieve in order to remove the very fines and obtain a coarser material.

Production step ii (treating the cellulosic raw material with an adhesive composition):

In a next step, the milled coconut husk was blended with the defined amount (10% solid adhesive content based on oven dry cellulosic raw material weight, e.g. 100 g solid adhesive content for 1000 g oven dry cellulosic raw material) of the solution of tannin in water (additionally including any additives if applicable) in a rotary tumble blender equipped with a spray nozzle through which the solution of tannin in water was sprayed.

The total mixing time was 7 min. If necessary, the initial moisture content (MC) of the cellulosic raw material was increased to the desired value in the blender prior to adding the adhesive solution. After blending, a raw mass was obtained.

Production step iii (compressing the raw mass):

The raw mass was placed and distributed in frames of different sizes (40×40 cm) and preformed by hand, in order to form mats before entering the hot press. Optionally, the boards were sprayed with the hydrophobic additives, as described above, and/or with water (in each case 15-25 g of the prepared hydrophobic additive water solution was sprayed at each surface (top and bottom) of the mat).

A Höfer lab press (80×60 cm) with pressure and speed control was used.

Different methods were used for compressing the raw mass and compared to each other (cf. Tables 1 and 2 below). The target thickness was 10 mm.

Program 1 (180° C.): Fast Closing (FC): Quick (within 1 sec) compression to 800% of the target thickness, followed by a (within 4 sec) compression to the target thickness. Once the target thickness is reached, the position is kept for 8 min. After those 8 minutes, the press is slowly opened (within 40 sec) until about 120% of the target thickness to gradually release any remaining steam or gas, before quickly returning to the starting position.

Program 2 (180° C.): Continuous Closing (CC): This program tries to simulate a continuous press by using a sequence of several compressing and pressure releasing steps. Therefore, the matt is first quickly (within 2 sec) compressed to the target thickness, then compressed to 86% first (for 2 sec), then 78% of the target thickness (for 4 sec), released again to 82% (for 4 sec), before finally releasing and allowing the raw mass to reach the target thickness, where the position is once again kept for a duration of 8 min. After those 8 minutes the press is slowly opened (within 40 sec) until about 120% of the target thickness in order to gradually release any remaining steam or gas, before quickly returning to the starting position.

Table 1 shows an embodiment of the compression program for fast closing (program 1):

| | Thickness | Ramp | Hold time | | | Temperature | |
|---|---|---|---|---|---|---|---|
| Steps | [mm] | [sec] | H | M | S | Top | Bottom |
| 1 | 240 | 1 | 0 | 0 | 1 | 182 | 182 |
| 2 | 80 | 4 | 0 | 0 | 1 | 182 | 182 |
| 3 | 10 | 1 | 0 | 8 | 0 | 182 | 182 |
| 4 | 12 | 40 | 0 | 0 | 10 | 182 | 182 |
| 5 | 240 | 4 | 0 | 0 | 1 | 182 | 182 |

Table 2 shows an embodiment of the compression program for continuous closing (program 2):

| | Thickness | Ramp | Hold time | | | Temperature | |
|---|---|---|---|---|---|---|---|
| Steps | [mm] | [sec] | H | M | S | Top | Bottom |
| 1 | 240 | 1 | 0 | 0 | 0 | 182 | 182 |
| 2 | 10 | 2 | 0 | 0 | 0 | 182 | 182 |
| 3 | 8.6 | 2 | 0 | 0 | 0 | 182 | 182 |
| 4 | 7.8 | 4 | 0 | 0 | 10 | 182 | 182 |
| 5 | 8.2 | 4 | 0 | 0 | 0 | 182 | 182 |
| 6 | 10 | 6 | 0 | 8 | 0 | 182 | 182 |
| 7 | 12 | 40 | 0 | 0 | 10 | 182 | 182 |
| 8 | 240 | 1 | 0 | 0 | 0 | 182 | 182 |

Sanding Step:

The resulting fiberboards were sanded by the following procedure: The edges of the boards were trimmed by about 40 mm and the top and bottom surfaces were sand down 0.5 to 0.7 mm with a 100-grit sandpaper.

The production steps, as outlined above, yielded fiberboards of 400×400 mm. These fiberboards were cut down to a final size, such as a final size of 320×320 mm.

The fiberboards, as well as the corresponding pressing parameters and conditions used during their production are listed in the table below. All fiberboards except MDC 32 were to manufactured as outlined above. MDC 32 was also manufactured as outlined above, except that the pressing time was 18 sec/mm and an adhesive composition was used which was prepared by adding to a 40% w/w solution of tannin in water an aqueous hexamine solution (40% w/w) to reach a dry weight ratio between hexamine and tannin of 7% w/w.

| Board | MDC 5 | MDC 18 | MDC 28 | MDC 30 | MDC 31 | MDC 32 |
|---|---|---|---|---|---|---|
| Cellulosic | Coconut | Coconut | Coconut | Coconut | Coconut | Coconut |
| Raw | Husk | Husk | Husk | Husk | Husk | Husk |
| Material | | | | | | |
| Tannin | Mimosa | Quebra- | Mimosa | Mimosa | Mimosa | Mimosa |
| | | cho | | | | |
| Mineral | No | No | No additive | No | No | No additive |
| additive | additive | additive | | additive | additive | |
| Hydro- | No | No | Hydrowax | Coconut | Sunflower | No additive |
| phobic | additive | additive | Spraying | oil | oil | |
| additive | | | technique | Spraying | Spraying | |
| | | | | technique | technique | |
| Milling | Method a) | Method a) | Method a) | Method a) | Method a) | Method a) |
| process | | | | | | |
| Compressing | Fast | Fast | Fast | Fast | Fast | Fast |
| program | Closing | Closing | Closing | Closing | Closing | Closing |
| Size of | 450 × 450 | 400 × 400 | 400 × 400 | 400 × 400 | 400 × 400 | 400 × 400 |
| fiber- | mm | mm | mm | mm | mm | mm |
| board as | | | | | | |
| produced | | | | | | |
| Size of | 370 × 370 | 320 × 320 | 320 × 320 | 320 × 320 | 320 × 320 | 320 × 320 |
| fiber- | mm | mm | mm | mm | mm | mm |
| board | | | | | | |
| after | | | | | | |
| trimming | | | | | | |
| Initial | 10% | 10% | 10% | 10% | 10% | 10% |
| moisture | | | | | | |
| content | | | | | | |
| Final | 17% | 19% | 17% | 18% | 18% | 22% |
| Moisture | | | | | | |
| content | | | | | | |

The initial moisture content refers to equilibrium moisture content of the cellulosic raw material before application of the adhesive.

The final moisture content refers to moisture content of the Cellulosic Raw Material after application of the adhesive.

Measurement and Characterization

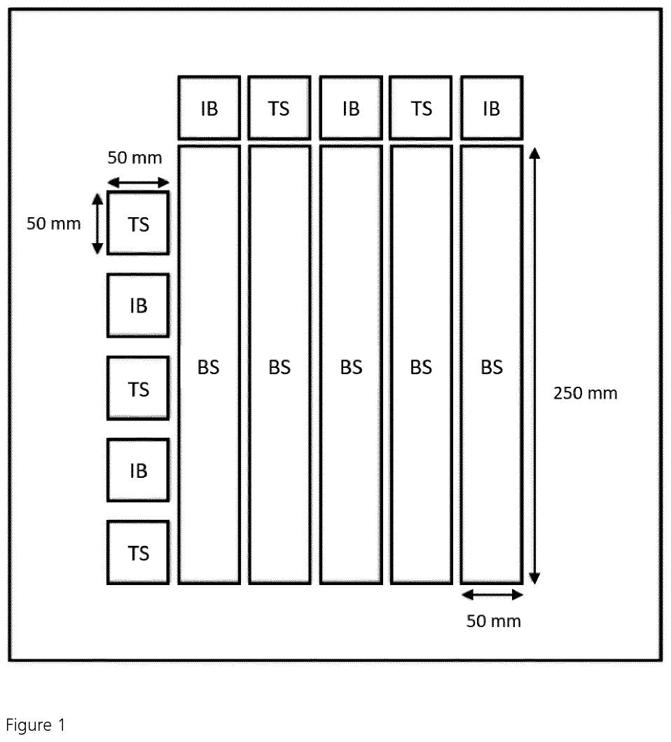

The sanded boards were cut (using a circular table saw) and labelled according to the cutting pattern of FIG. 1 in order to obtain five 50×50 mm specimens for carrying out the water absorption (WA) and thickness swelling (TS) tests, another five 50×50 mm to samples for determining the internal bonding (IB) properties and five 250×50 mm specimens for measuring the modulus of elasticity (MOE) and bending strength (BS) of the fiberboards.

Determination of modulus of elasticity in bending (MOE) and bending strength (BS):

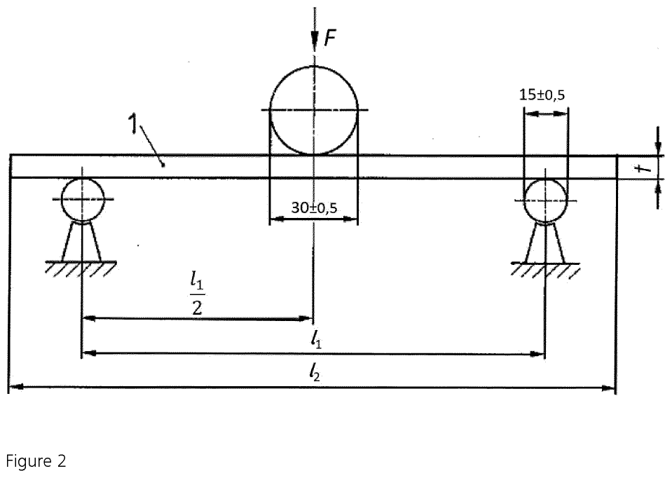

Modulus of elasticity (MOE) and bending strength (BS) were determined for each fiberboard according to DIN EN 310 standard (1993; also see FIG. 2). Therefore, a universal Zwick tensile testing machine with a 20 kN load cell was used. The tests were run at a constant cross-head speed of 14-16 mm/min. The thickness, width and length of the samples were measured by means of a calliper. In the case of the thickness, the values were measured at 3 points at each side for each sample and an average value of the 3 measurements was considered. A total of 5 samples were performed per each board formulation. Before carrying out the tests, all samples were stored in a conditioning chamber at 20° C. and 65% RH for at least 24 hours until stabilization of the weight. In accordance with EN 310, stabilization of the weight is achieved when the weight deviation is no more than 0.1% within 24 hours. Load and displacement were recorded until specimen failure. The average testing time was 53 seconds. Average values, as well as extrapolated values for a density of 750 kg/m 3 were reported.

FIG. 2 shows the bending test setup according to DIN EN 310 (1993), wherein 1 denotes the specimen (Prufkorper), F denotes the force, t denotes the thickness of the specimen, l₁=20t and l₂=l₁+50. All measures given in FIG. 2 are given in millimeters.

Determination of tensile strength perpendicular to the plane of the fiberboard (IB test):

Tensile strength perpendicular to the plane of the fiberboard (Internal Bonding (IB) test) was measured for each board according to DIN EN 319 standard (1993). Therefore, a universal Zwick tensile testing machine with a 20 kN load cell was used. The tests were run at a constant cross-head speed of 0.6 mm/min. The thickness, width and length of the samples were measured by means of a calliper and a dial gauge. A total of 5 samples were performed per each board formulation. Before carrying out the tests, all samples were stored in a conditioning chamber at 20° C. and 65% RH for at least 24 hours. Load and displacement were recorded until specimen failure. The average testing time was 57 seconds. Average values, as well as extrapolated values for a density of 750 kg/m 3 were reported.

Determination of swelling in thickness (TS) after immersion in water:

Thickness swelling (TS) (which was determined according to DIN EN 317 standard (1993)) and water absorption (WA) were determined for each board as follows: Therefore, 50×50 mm samples were immersed in a closed plastic box filled with water for 24 h. The thickness, width and length of the samples as well as the weight were measured by means of a calliper, a dial gauge and a scale. A total of 5 samples were tested for each board formulation. Before carrying out the tests, all samples were stored in a conditioning chamber at 20° C. and 65% RH for at least 24 hours. Average values, as well as extrapolated values for a density of 750 kg/m 3 were reported.

The following tables contain an overview of the average values (5 samples) of the measured mechanical and physical properties of the fiberboards, which were produced as disclosed above.

| Board | MDC 5 | MDC 18 | MDC 28 | MDC 30 | MDC 31 | MDC 32 |
|---|---|---|---|---|---|---|
| Density (kg/m³) | 672 | 730 | 753 | 733 | 728 | 767 |
| Modulus of | 1366 | 1860 | 1906 | 1794 | 1744 | 2064 |
| elasticity | | | | | | |
| (MOE, N/mm²) | | | | | | |
| Bending | 13.68 | 17.52 | 17.74 | 17.86 | 16.20 | 19.5 |
| strength | | | | | | |
| (BS, N/mm²) | | | | | | |

| Board | MDC 5 | MDC 18 | MDC 28 | MDC 30 | MDC 31 | MDC 32 |
|---|---|---|---|---|---|---|
| Density (kg/m³) | 712 | 678 | 676 | 712 | 686 | 759 |
| Tensile strength | 0.61 | 0.49 | 0.48 | 0.36 | 0.55 | 0.9 |
| perpendicular | | | | | | |
| to plane | | | | | | |
| (IB N/mm²) | | | | | | |

| Board | MDC 5 | MDC 18 | MDC 28 | MDC 30 | MDC 31 | MDC 32 |
|---|---|---|---|---|---|---|
| Density (kg/m³) | 683 | 669 | 740 | 735 | 704 | 763 |
| Water | 87% | 89% | 63% | 63% | 71% | 58% |
| absorption | | | | | | |
| (WA %) | | | | | | |
| Thickness | 18% | 19% | 11% | 12% | 12% | 10% |
| swelling | | | | | | |
| (TS %) | | | | | | |

The following table contains an overview of the average values (5 samples) of the mechanical and physical properties of the fiberboards, which were extrapolated for a density of 750 kg/m³.

| Board | MDC 5 | MDC 18 | MDC 28 | MDC 30 | MDC 31 | MDC 32 |
|---|---|---|---|---|---|---|
| Water | 70% | 61% | 60% | 58% | 58% | 63% |
| absorption | | | | | | |
| (WA %) | | | | | | |
| Thickness | 16% | 14% | 11% | 11% | 10% | 11% |
| swelling | | | | | | |
| (TS %) | | | | | | |
| Tensile strength | 0.77 | 0.75 | 0.65 | 0.74 | 0.89 | 0.88 |
| perpendicular | | | | | | |
| to plane | | | | | | |
| (IB N/mm²) | | | | | | |
| Modulus of | 2017 | 2069 | 1914 | 1964 | 1922 | 1904 |
| elasticity | | | | | | |
| (MOE, N/mm²) | | | | | | |
| Bending | 20.61 | 19.57 | 17.77 | 19.27 | 18.46 | 18.18 |
| strength (BS) | | | | | | |

1. A method for producing a compressed cellulosic fiber product, the method comprising the steps of:
providing cellulosic raw material comprising cellulosic fibers;
treating the cellulosic raw material with an adhesive composition to obtain a raw mass; and
compressing the raw mass in a pre-defined form to effect condensation to obtain the compressed cellulosic fiber product.

2. The method according to claim 1, wherein the cellulosic raw material derives from coconut husk, rice husk, wheat straw, rice straw, bagasse, hemp, or kenaf, preferably coconut husk.

3. The method according to claim 1, wherein the cellulosic raw material is husk-derived raw material.

4. The method according to claim 1, wherein the cellulosic raw material further comprises pith.

5. The method according to claim 4, wherein the cellulosic raw material comprises a first fraction and a separate second fraction, wherein the first fraction of the cellulosic raw material is made of at least 90 wt-% cellulosic fibers and the second fraction of the cellulosic raw material is made of at least 90 wt-% pith.

6. The method according to claim 5, wherein during the step of treating the cellulosic raw material with an adhesive composition, the first fraction of the cellulosic raw material and second fraction of the cellulosic raw material are separately treated with the adhesive composition.

7. The method according to claim 4, wherein the ratio of cellulosic fibers to pith is 40%-60%, particularly 50%, pith and 60%-40%, particularly 50%, cellulosic fiber (w/w).

8. The method according to claim 1, wherein the cellulosic raw material further comprises a filling material.

9. The method according to claim 1, wherein the cellulosic fibers have a length of 0.3 cm-5 cm and a diameter of 5-40 microns.

10. The method according to claim 1, wherein the adhesive composition includes tannin.

11. The method according to claim 10, wherein the tannins are derived from quebracho wood (Schinopsis lorentzii and Schinopsis balansae), mimosa bark (Acacia mearnsii), grape seeds (Vitis vinifera), pine barks, spruce barks or mangium bark (Acacia mangium).

12. The method according to claim 10, wherein the adhesive composition further includes hexamine.

13. The method according to claim 1, wherein the step of treating the cellulosic raw material with an adhesive composition includes blending the cellulosic raw material with the adhesive composition, preferably using a rotary tumble blender or a rotary continuous mixer.

14. The method according to claim 1 any one of the preceding claims, wherein the step of compressing the raw mass includes the steps of:
preforming the raw mass and
hot-compressing the preformed raw mass to obtain the compressed cellulosic fiber product.

15. The method according to claim 14, wherein the step of hot-compressing the preformed raw mass is performed at 150-220° C.

16. (canceled)

17. The method according to claim 1, wherein the compressed cellulosic fiber product is a fiberboard, with a length of 300-500 mm, a width of 300-500 mm, and a thickness of 5-30 mm.

18. A compressed cellulosic fiber product manufactured from cellulosic raw material by the method according to claim 1, wherein the compressed cellulosic fiber product has a density between 600 and 900 kg/m³, preferably between 700 and 800 kg/m³, more preferably 750 kg/m³.

19. The compressed cellulosic fiber product according to claim 18, wherein the cellulosic raw material is derived from coconut husk.

20. The compressed cellulosic fiber product according to claim 18, wherein the compressed cellulosic fiber product is a fiberboard.

21. The fiberboard according to claim 20, wherein the tensile strength perpendicular to the plane of the fiberboard lies above 0.6 N/mm², as determined according to DIN EN 319.

22. The fiberboard according to claim 20, wherein the modulus of elasticity of the fiberboard lies between 1800 and 2500 N/mm2, as determined according to DIN EN 310.

23. The fiberboard according to claim 20, wherein the bending strength of the fiberboard lies above 15 N/mm2, as determined according to DIN EN 310.

24. The fiberboard according to claim 20, wherein the thickness swelling of the fiberboard lies below 20%, as determined according to DIN EN 317.

25. The fiberboard according to claim 20, wherein the water absorption of the fiberboard lies below 75%.

26. The method according to claim 10, wherein the adhesive composition includes condensed tannin.

27. The method according to claim 12, wherein the dry weight ratio of hexamine and tannin is between 1:19 and 1:10.

28. The method according to claim 27, wherein the dry weight ratio of hexamine and tannin is 1:13.
